(19) United States
(12) Patent Application Publication
(10) Pub. No.: US 2026/0089402 A1
(43) Pub. Date: Mar. 26, 2026

(54) IMAGE CAPTURING APPARATUS, IMAGE CAPTURING METHOD, AND STORAGE MEDIUM

(71) Applicant: CANON KABUSHIKI KAISHA, Tokyo (JP)

(72) Inventor: ATSUTO SUGAYA, Kanagawa (JP)

(21) Appl. No.: 19/307,303

(22) Filed: Aug. 22, 2025

(30) Foreign Application Priority Data
Sep. 26, 2024 (JP) 2024-167659

(51) Int. Cl. H04N 23/75; H04N 23/73; H04N 25/705

(52) U.S. Cl. CPC H04N 23/75; H04N 23/73; H04N 25/705

(57) ABSTRACT

An image capturing apparatus includes an optical device including an ND filter, a control unit, a memory that stores instructions, and a processor. The processor executes the stored instructions to cause the control unit to control at least two exposure parameters, insert and remove the ND filter into and from an optical axis of the optical device, and analyze a depth of an image capturing range, a movement of a subject, or an importance of a scene. The executing the stored instructions by the processor further causes the control unit to, at a time at which insertion and removal of the ND filter is performed, perform exposure control so as to offset brightness changes of output images accompanying the insertion and removal of the ND filter by using a combination of the exposure parameters and control amounts determined based on a result of the analyzing.

### BACKGROUND

### Field of the Technology

The present disclosure relates to an image capturing apparatus, an image capturing method, a storage medium, and the like that are suitable for applications such as surveillance.

### Description of the Related Art

Conventionally, there are cameras that incorporate ND (Neutral Density) filters in order to expand a proper exposure range. In a case in which a plurality of ND filters are mounted, enlargement of the main body and increased costs are caused, and accordingly, a single high-density ND filter is sometimes adopted. In addition, for the purpose of expanding a proper range of automatic exposure control, there are cameras that automatically insert and remove ND filters under certain illuminance conditions during automatic exposure control.

In a case in which insertion and removal of a high-density ND filter is performed during automatic exposure control, other exposure parameters (aperture, shutter, gain) automatically change for the purpose of offsetting brightness changes accompanying ND filter insertion and removal. At this time, aspects of image quality such as depth of field, motion resolution, noise amount, and the like also changes significantly. In a case in which a fixed program line diagram preset in a camera is used, this change in image quality may adversely affect scene visibility.

For example, in Japanese Patent Application Laid-Open No. 2005-045648, for the purpose of shortening a period during which exposure varies in accordance with ND filter insertion and removal, reduction of the number of frames in which image quality deterioration occurs is achieved by discontinuously controlling exposure simultaneously with ND filter insertion and removal.

In addition, when ND filters are inserted and removed, the state of ND filter insertion and removal is reflected in moving images being captured, and frames having severe brightness changes and low visibility occur. Accordingly, when ND filter insertion and removal is performed based only on illuminance conditions, the performance of ND filter insertion and removal based only on illuminance conditions could potentially reduce the evidentiary value of images of important scenes in surveillance cameras.

In addition, in the technology disclosed in Japanese Patent Application Laid-Open No. 2005-045648, since ND filter insertion and removal is performed at a predetermined illuminance determined in advance, frames in which image quality deterioration occurs are generated in a case in which the predetermined illuminance is reached in important scenes in surveillance applications.

In addition, since exposure parameters used to offset brightness changes accompanying ND filter insertion and removal are fixed, there is an issue in that image quality changes appear prominently.

### SUMMARY

The present disclosure is directed to provide an image capturing apparatus configured to reduce image quality deterioration before and after ND filter insertion and removal.

According to an aspect of the present disclosure, an image capturing apparatus includes an optical device including an ND filter, a control unit, a memory that stores instructions, and a processor. The processor executes the stored instructions to cause the control unit to control at least two exposure parameters, insert and remove the ND filter into and from an optical axis of the optical device, and analyze a depth of an image capturing range, a movement of a subject, or an importance of a scene. The executing the stored instructions by the processor further causes the control unit to, at a time at which insertion and removal of the ND filter is performed, perform exposure control so as to offset brightness changes of output images accompanying the insertion and removal of the ND filter by using a combination of the exposure parameters and control amounts determined based on a result of the analyzing.

Features of the present disclosure will become apparent from the following description of embodiments with reference to the attached drawings. The following description of embodiments is described by way of example.

### BRIEF DESCRIPTION OF THE DRAWINGS

FIG. 1 is a functional block diagram showing a configuration example of an image capturing apparatus 100 according to a First Embodiment of the present disclosure.

FIG. 2 is a diagram showing an example of a program line diagram that serves as a reference during ND filter insertion according to the First Embodiment.

FIG. 3 is a flowchart showing an example of ND filter insertion and removal and exposure control accompanying the ND filter insertion and removal according to the First Embodiment.

FIG. 4A and FIG. 4B are diagrams for explaining use cases of a state in which depth is small and a state in which depth is large in image capturing scenes.

FIG. 5A and FIG. 5B are diagrams showing examples of program line diagrams regenerated in step S305 of FIG. 3.

FIG. 6 is a diagram showing an example of a program line diagram that serves as a reference during ND filter removal according to the First Embodiment.

FIG. 7A and FIG. 7B are diagrams showing examples of program line diagrams regenerated during ND filter removal according to the First Embodiment.

FIG. 8 is a flowchart showing an example of ND filter insertion and removal and exposure control accompanying the ND filter insertion and removal according to a Second Embodiment.

FIG. 9A and FIG. 9B are diagrams showing examples of program line diagrams regenerated during ND filter insertion according to the Second Embodiment.

### DESCRIPTION OF THE EMBODIMENTS

Hereinafter, embodiments of the present disclosure will be explained with reference to the drawings. However, the present disclosure is not limited to the embodiments described below. It should be noted that in each drawing, same reference numerals are assigned with respect to same members or elements, and duplicate explanations are omitted or simplified.

### First Embodiment

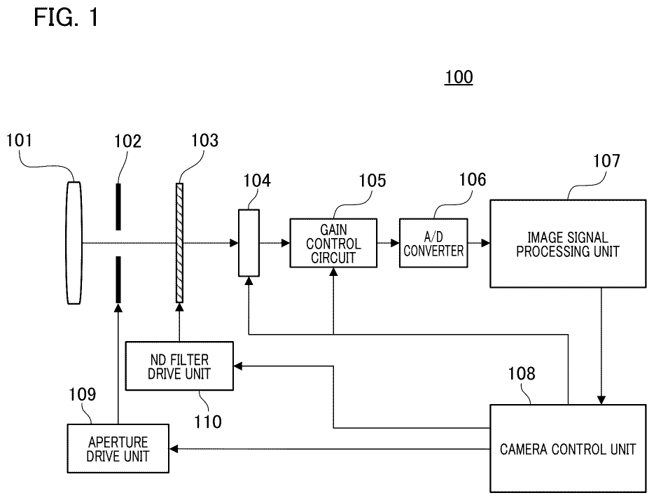

FIG. 1 is a functional block diagram showing a configuration example of an image capturing apparatus 100 according to a First Embodiment of the present disclosure. It should be noted that some of the functional blocks shown in FIG. 1 are realized by causing a CPU and the like serving as a computer (not shown) included in the image capturing apparatus 100 to execute a computer program stored in a memory serving as a storage medium (not shown).

However, some or all of the functional blocks may be realized by using hardware. As hardware, a dedicated circuit (ASIC), a processor (reconfigurable processor, DSP), and the like can be used. In addition, the respective functional blocks shown in FIG. 1 need not be built into the same housing, and the functional blocks may be configured by separate apparatuses connected to each other via signal paths.

As shown in FIG. 1, the image capturing apparatus 100 comprises a lens 101, an aperture 102, an ND filter 103, an image capturing element 104, a gain control circuit 105, an A/D converter 106, an image signal processing unit 107, a camera control unit 108, an aperture drive unit 109, and an ND filter drive unit 110. The lens 101, the aperture 102, the ND filter 103, and the image capturing element 104 configure an optical system (optical device) of the image capturing apparatus 100.

The lens 101 is an optical system that forms an image of light incident from a subject on the image capturing element 104. The lens 101 includes a focus lens that performs focusing with respect to the subject, a zoom lens that adjusts an angle of view, and the like.

The aperture 102 (aperture diaphragm) is driven by the aperture drive unit 109, and is used for controlling an amount of light incident on a light receiving surface of the image capturing element 104 via the lens 101.

The ND filter 103 is an achromatic Neutral Density filter for reducing an incident light amount, and is configured to be selectively insertable into and removable from an optical axis of the lens 101 by the ND filter drive unit 110. Here, the ND filter drive unit 110 functions as a filter insertion and removal unit for inserting the ND filter onto, and removing the ND filter from, an optical axis.

The image capturing element 104 is, for example, a CMOS image sensor or a CCD image sensor, and converts a subject image formed by the lens 101 into an analog image signal.

The gain control circuit 105 controls gain of an electrical signal output from the image capturing element 104, and performs brightness adjustment of the analog image signal.

The A/D converter 106 converts the analog image signal that has been amplified and processed by the gain control circuit 105 into a digital image signal.

Processing by the image signal processing unit 107 and the camera control unit 108 is executed by a CPU and the like serving as a computer within the camera control unit 108. That is, the CPU within the camera control unit 108 performs control of the image signal processing unit 107 and the entire image capturing apparatus 100 by executing a computer program read out from a memory apparatus (not shown).

The image signal processing unit 107 performs various types of processing such as color conversion processing, gamma correction, addition of digital gain, and the like on the digital image signal. In addition, the image signal processing unit 107 performs predetermined calculation processing by using the digital image signal, and sends calculation results to the camera control unit 108.

The camera control unit 108 performs exposure control, focus detection, focus adjustment control, white balance control, and the like based on the calculation results supplied from the image signal processing unit 107. Thereby, AF (autofocus) processing, AE (auto exposure) processing, AWB (auto white balance) processing, and the like are performed.

In addition, the camera control unit 108, along with controlling the image capturing element 104, the gain control circuit 105, the image signal processing unit 107, and the aperture drive unit 109, also changes aperture values and shutter speeds and performs insertion and removal of the ND filter via the ND filter drive unit 110. Furthermore, the camera control unit 108 changes exposure by adjusting analog gain and digital gain.

In this manner, the camera control unit 108 functions as exposure control unit for executing an exposure control step that controls at least two or more exposure parameters. That is, the exposure control unit controls at least two of an aperture diaphragm for controlling an amount of light incident on the light receiving surface, a shutter speed, and a gain as exposure parameters. It should be noted that the shutter speed in the present embodiment may be an exposure time by a mechanical shutter or may be a charge accumulation time by the image capturing element.

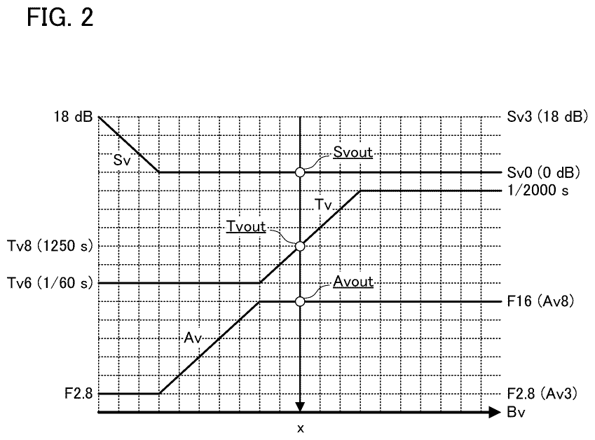

Hereinafter, with reference to FIG. 2 to FIG. 7B, an explanation will be provided with respect to operation of the image capturing apparatus according to the First Embodiment of the present disclosure. FIG. 2 is a diagram showing an example of a program line diagram that serves as a reference during ND filter insertion according to the First Embodiment.

The line diagrams of FIG. 2 and FIG. 5A to FIG. 7B are stored in a memory device (not shown). Alternatively, the line diagrams may be stored in a network or various storage media.

As a premise for the explanation, the image capturing apparatus 100 is executing AE processing according to the program line diagram shown in FIG. 2 in a case in which the image capturing apparatus 100 is in an initial state in which the ND filter 103 is removed from an image capturing optical path, and an absolute brightness value (Bv) calculated from an image signal of a subject is less than an ND filter insertion brightness x.

In the present embodiment, in this state, in a case in which the image capturing apparatus 100 is hypothetically instructed, via an external interface (not shown), to fix the state in which the ND filter 103 is removed, the program line diagram of FIG. 2 is used. Accordingly, hereinafter, the program line diagram of FIG. 2 serves as a reference line diagram.

It should be noted that the program line diagram (reference line diagram) of FIG. 2 functions as a first program line diagram predetermining transitions of a plurality of exposure parameters corresponding to brightness of the subject.

Here, the program line diagram is a table that represents allocation of the aperture Av, the shutter speed Tv, and the gain Sv with respect to the absolute brightness value Bv, and the aperture Av, the shutter speed Tv, and the gain Sv each have the relationship of Equation 1 shown below. It should be noted that ΔY is an exposure difference (difference between a proper exposure value and a current exposure value) calculated in the image signal processing unit 107.

$$Bv = Av + Tv - Sv + Δ Y \qquad ( Equation 1 )$$

The camera control unit 108 controls respective units according to the program line diagram shown in FIG. 2, and maintains proper brightness of images by reducing the exposure difference ΔY.

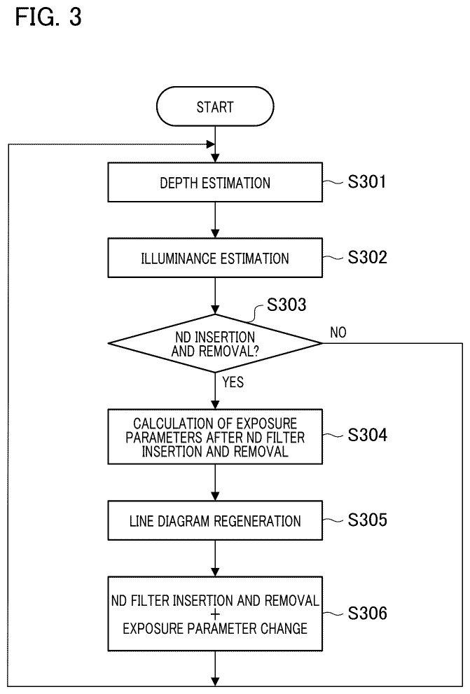

FIG. 3 is a flowchart showing an example of ND filter insertion and removal and exposure control accompanying the ND filter insertion and removal according to the First Embodiment. It should be noted that operations of respective steps of the flowchart of FIG. 3 are performed sequentially by causing a CPU and the like serving as a computer within the camera control unit 108 to execute a computer program stored in memory.

Here, the above-described memory functions as a computer-readable storage medium that stores a program for causing a computer to execute the respective steps thereof.

It should be noted that the flowchart of FIG. 3 shows an example of a processing flow applied to both a case in which the ND filter 103 is inserted and a case in which the ND filter 103 is removed, and first, an explanation will be provided with respect to a case in which the ND filter 103 is inserted in a state in which the ND filter 103 is not inserted.

In step S301, the camera control unit 108 estimates depth of an image capturing range. That is, the camera control unit 108 may, by estimating a defocus amount of a subject by using a contrast evaluation value calculated by the image signal processing unit 107 for AF processing, infer a subject distance corresponding to the defocus amount, and estimate depth of the image capturing range.

Alternatively, the camera control unit 108 may estimate a range of distance to the subject based on a depth map generation result obtained by using machine learning on a two-dimensional image, and the like. Instead of the contrast evaluation value, a phase difference detection output from the image capturing element or a distance measurement value acquired by a TOF (Time of Flight) sensor may be used.

In addition, the camera control unit 108 may estimate a distance between a foremost part and a rearmost part of a predetermined subject as depth instead of a distance of an entire image capturing range by recognizing a predetermined subject such as a person, a vehicle, and the like from an image. In addition, the predetermined subject may be made selectable according to a target of attention of a user via an external interface (not shown). For example, only a person, only a vehicle, a person and a vehicle, and the like may be made selectable as the predetermined subject.

It should be noted that step S301 here functions as a scene analysis step (scene analysis unit) that analyzes depth of the image capturing range. It should be noted that depth here includes distance information from the image capturing apparatus to at least a plurality of subjects.

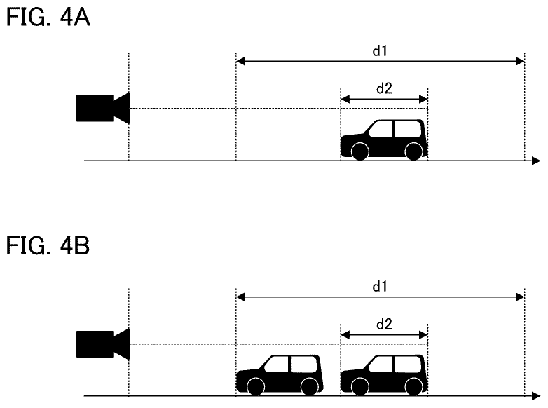

FIG. 4A and FIG. 4B are diagrams for explaining use cases of a state in which depth of an image capturing range is small and a state in which depth of an image capturing range is large in image capturing scenes, and show an example of a vehicle as the predetermined subject. In a case in which only one subject exists in the image capturing range as shown in FIG. 4A, a depth of field necessary for the image capturing scene is relatively small, and even in a case in which the depth of field changes from d1 to d2 accompanying variation of the aperture, a large difference does not occur in visibility of a subject of interest.

In contrast, in a case in which a plurality of subjects exist as shown in FIG. 4B and there is a distance difference with respect to the image capturing apparatus, a depth of field necessary for the image capturing range is relatively large, and accordingly, when the depth of field changes from d1 to d2, subjects fall outside the depth of field, and accordingly visibility is reduced. In such a case, maintaining a small aperture becomes necessary.

In step S302, the camera control unit 108 performs estimation of illuminance (brightness) based on the exposure difference ΔY calculated in the image signal processing unit 107, and updates the absolute brightness value Bv. It should be noted that the order of processing of step S301 and processing of step S302 may be reversed.

In step S303, the camera control unit 108 determines whether to perform insertion and removal of the ND filter 103. That is, in a case in which the ND filter 103 is inserted from a state in which the ND filter 103 is not inserted initially, the camera control unit 108 compares the current absolute brightness value Bv with an ND filter insertion brightness x, and determines whether or not to insert the ND filter 103.

In a case in which the absolute brightness value Bv exceeds the ND filter insertion brightness x, the camera control unit 108 determines Yes in step S303, and transitions to step S304. In contrast, in a case in which No is determined in step S303, the camera control unit 108 transitions to step S301.

In step S304, the camera control unit 108 calculates, for example, the exposure parameters after ND filter insertion, that is, aperture, shutter speed, and gain.

Here, before ND filter insertion, the aperture is Avout, the shutter speed is Tvout, and the gain is Svout, and after ND filter insertion, the aperture is Avin, the shutter speed is Tvin, and the gain is Svin. In addition, in a case in which a change amount of the absolute brightness value Bv caused by ND filter insertion is Nvin, the above-described exposure parameters satisfy the relationship of Equation 2 shown below.

$$Avin + Tvin - Svin + Nvin = Avout + Tvout - Svout \qquad ( Equation 2 )$$

Equation 2 represents that the change amount Nvin of the absolute brightness value Bv caused by ND filter insertion can be offset by at least one of aperture, shutter speed, and gain. That is, for example, if an image becomes darker by 3 stops due to ND filter insertion, the change amount Nvin of the absolute brightness value Bv can be offset by opening the aperture by 3 stops.

Alternatively, the shutter speed may be made slower by 3 stops. Alternatively, the aperture may be opened by 1 stop, the shutter speed may be made slower by 1 stop, and the gain may also be increased by an amount corresponding to 1 stop. Allocation of change amounts of these respective parameters can be performed freely.

It should be noted that in the present embodiment, in step S304, the camera control unit 108 first determines the aperture Avin after ND filter insertion based on the depth estimated in step S301. Specifically, the camera control unit 108 determines the aperture Avin after ND filter insertion based on at least one of subject distance, permissible circle of confusion diameter, focal length, and the like in accordance with accuracy and likelihood of an estimation result of the depth obtained in step S301.

For example, in a case in which estimation of a specific subject distance of the depth is impossible, preset aperture values such as an aperture value of F16 in a case in which the depth is large and F2.8 in a case in which the depth is small may be used based on magnitude of the depth.

In contrast, in a case in which estimation of a specific subject distance of the depth is possible, as described above, an aperture value necessary for accommodating a plurality of subjects within the depth of field can be calculated based on at least one of subject distance, permissible circle of confusion diameter, focal length, and the like. In addition, adjustment of the focus lens position based on a difference between front depth of field and rear depth of field may also be performed.

Subsequently, the camera control unit 108 calculates Tvin and Svin based on Equation 2 and the reference line diagram of FIG. 2. Here, an explanation will be provided with respect to a calculation method of Tvin and Svin in a case in which, for example, x=16, Avout=8 (F16), Tvout=8 ( 1/250 s), Svout=0 (0 dB), and Nvin=6 after ND filter insertion.

In a case in which the depth of field necessary for the image capturing scene is relatively small and Avin=4 (F4), based on Equation 2, Tvin−Svin=6.

In addition, in the reference line diagram of FIG. 2, in a case in which the absolute brightness value Bv decreases, the camera control unit 108 first decreases Tv to Tv=6 ( 1/60 s), next decreases Av to Av=3 (F2.8), and finally increases Sv to Sv=3 (18 dB). Accordingly, in accordance with the transition order of the respective parameters of the reference line diagram, Tvin is set to 6 ( 1/60 s). In addition, since Tvin−Svin=6 as described above, Svin=0 is calculated.

In contrast, in a case in which the depth of field necessary for the image capturing scene is relatively large and the aperture Avin after ND filter insertion is Avin=7 (F11), Tvin−Svin=3 based on Equation 2. Accordingly, in accordance with the transition order of the reference line diagram, Tvin is set to 6 ( 1/60 s).

Although Av=3 (F2.8) would subsequently follow according to the reference line diagram of FIG. 2, since Avin=7 has already been determined, attention is instead focused on the transition of Sv, and Svin is determined to be 3 by calculating a value satisfying Tvin−Svin=3 within the range up to Sv=3 (18 dB).

As described above, in the present embodiment, after Avin is determined, Tvin and Svin are uniquely determined in accordance with a value of Nvin (change amount of the absolute brightness value Bv caused by ND filter insertion) and the transition order of each parameter of the reference line diagram.

In step S305, the camera control unit 108 performs regeneration of the program line diagram. That is, since Avin, Tvin, and Svin calculated in step S304 do not follow the reference line diagram of FIG. 2, continuous AE processing becomes impossible at the next update of the absolute brightness value Bv.

A range in which regeneration of the line diagram becomes necessary is a range in which brightness is from (x-y) to (x+Nvin). Here, x-y is an absolute brightness value Bv serving as a threshold for removing the ND filter 103 again, and Nvin is the change amount of the absolute brightness value Bv caused by ND filter insertion as described above.

After the ND filter 103 is inserted upon exceeding the ND filter insertion brightness x, x-y is set so that the ND filter 103 is not removed again in reaction to minute changes in the image capturing environment, and insertion and removal is not repeated. That is, once the ND filter is inserted, the ND filter is set so that ND filter removal is not performed unless brightness decreases by a predetermined width y from the ND filter insertion brightness x, for example. In the present embodiment, an explanation will be provided using y=2.

In a case in which the absolute brightness value Bv falls below x-y, removal of the ND filter 103 is performed, and recalculation of Avout, Tvout, and Svout and regeneration of the program line diagram are performed, and accordingly, a program line diagram corresponding to the absolute brightness value Bv falling below x-y is basically unnecessary.

However, in a case in which the image capturing apparatus 100 is hypothetically instructed, via an external interface (not shown), to be locked in a state in which the ND filter 103 is inserted, the reference line diagram serves as an alternative line diagram as described later. Thereby, exposure parameter setting corresponding to an absolute brightness value (Bv) that falls below x-y can also be performed.

In this manner, in step S305, after insertion and removal of the ND filter 103, a second program line diagram is generated based on a combination of the first program line diagram (reference line diagram) and the exposure parameters.

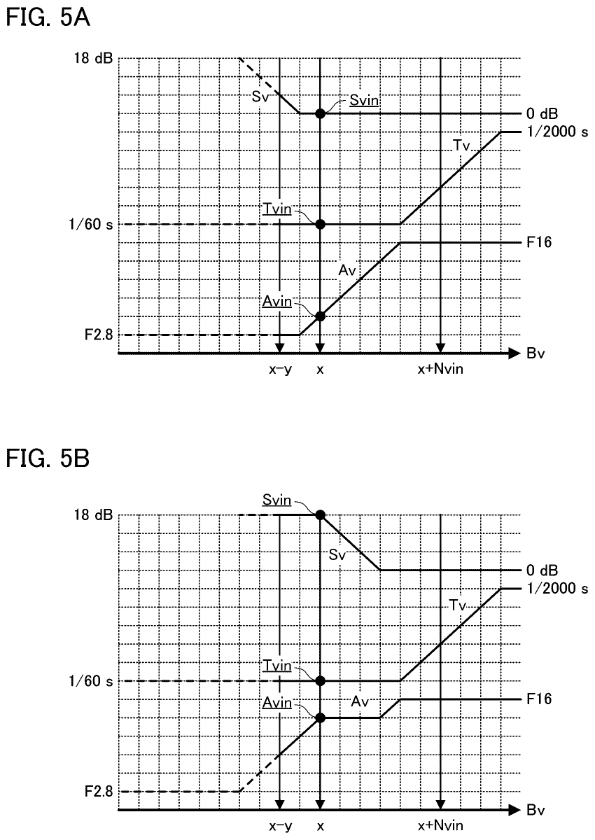

FIG. 5A and FIG. 5B are diagrams showing examples of program line diagrams regenerated in step S305, wherein FIG. 5A shows a program line diagram regenerated in a case in which Avin=4 (F4), and FIG. 5B shows a program line diagram regenerated in a case in which Avin=7 (F11). With respect to regeneration of program line diagrams as well, similar to step S304, the transition order of the reference line diagram is followed.

That is, as shown in FIG. 5A, in a case in which the program line diagram starts from Avin=4 (F4) when Bv=x, in accordance with the transition order of the respective parameters of the reference line diagram in the range from x to (x−y), first, Tv is set to 6 ( 1/60 s). However, as described above, since Tvin is already 6 ( 1/60 s), a transition is unnecessary.

Although Av is set to 3 (F2.8) in a case in which brightness decreases by an amount corresponding to 1 stop, since only a line diagram reflecting a 1-stop decrease from Avin=4 (F4) can be regenerated, a transition is subsequently made so as to increase Sv in a case in which brightness further decreases by an amount corresponding to 1 stop. That is, since y=2, for the remaining amount corresponding to 1 stop, a line diagram that transitions to increase up to Sv=1 (6 dB) may be generated.

In FIG. 5A, conversely, the range from x to (x+Nvin) follows the transition order of the respective parameters in a case in which the absolute brightness value Bv increases in the reference line diagram. That is, as shown in FIG. 5A, when Bv=x, first, Sv is set to 0 (0 dB), and subsequently, the line diagram transitions so as to increase up to Av=8 (F16), and thereafter, the line diagram transitions so as to increase Tv.

That is, first, Sv is set to 0 (0 dB), and since Sv is already 0 (0 dB), a transition is unnecessary. Subsequently, although the line diagram transitions so as to increase up to Av=8 (F16) as brightness increases by an amount corresponding to 4 stops, since only a transition that increases by 4 stops from Avin=4 (F4) can be regenerated, a transition is made so as to increase Tv in a case in which brightness further increases.

However, since Nvin=6 in FIG. 5A and FIG. 5B, with respect to the remaining amount corresponding to 2 stops, a line diagram that transitions so as to increase Tv by an amount corresponding to 2 stops up to Tv=8 ( 1/250 s) may be generated. The line diagram in the range exceeding x+Nvin is the same as the reference line diagram.

In contrast, as shown in FIG. 5B, in a case in which the program line diagram starts from Avin=7 (F11) at Bv=x, in the range from x to (x−y), in accordance with the transition order of the respective parameters of the reference line diagram, first, Tv is set to 6 ( 1/60 s). However, since Tvin is already 6 ( 1/60 s), a transition is unnecessary.

Subsequently, although the line diagram transitions so that Av decreases toward Av=3 (F2.8), it is sufficient to generate a line diagram that transitions from Avin=7 (F11) down two stops to Av=5 (F5.6)

With respect to the range from x to (x+Nvin), although a transition is first made so as to decrease Sv, because only a transition down to Sv=0 that is made by decreasing Sv by an amount corresponding to 3 stops from Svin=3 (18 dB) can be regenerated, a transition is thereafter made so as to increase Av.

That is, although Av is increased toward Av=8 (F16), since only a 1-stop transition from Avin=7 (F11) can be regenerated, a transition is subsequently made so as to increase Tv. Since Nvin=6, for brightness increase of the remaining amount corresponding to 2 stops, a line diagram that transitions so that Tv increases up to Tv=8 ( 1/250 s) may be generated. The line diagram shape of the range exceeding x+Nvin is the same as the reference line diagram.

As described above, after Avin, Tvin, and Svin after ND filter insertion are determined in step S304, regeneration of the line diagram is performed in accordance with rules of the transition order of control parameters of the reference line diagram. At that time, regeneration of the line diagram is possible for the range in which the absolute brightness value Bv is from (x−y) to (x+Nvin), wherein (x−y) is the ND filter removal brightness.

Next, in step S306, the camera control unit 108 inserts the ND filter 103, and simultaneously, controls each unit so that the post-ND-filter-insertion exposure parameters become Avin, Tvin, and Svin, based on the second program line diagram calculated in step S304.

That is, after insertion and removal of the ND filter 103, in step S306, automatic exposure control is performed based on the second program line diagram generated from a combination of the first program line diagram and the exposure parameters.

Here, step S306 functions as a filter insertion and removal step wherein the ND filter 103 is inserted into and removed from the optical axis. It should be noted that the second program line diagram regenerated in step S305 is set as the program line diagram to be referenced in subsequent AE processing. Thereafter, the processing returns to step S301.

That is, in the exposure control step of FIG. 3, in a case in which ND filter insertion and removal is performed, exposure control is performed so as to offset brightness changes of output images accompanying ND filter insertion and removal by using a combination of exposure parameters and control amounts determined based on the analysis results obtained by the scene analysis unit.

Specifically, in the exposure control step, the aperture diaphragm is controlled based on depth of the subject, and at least one of shutter speed and the gain is controlled so as to offset brightness changes at the light receiving surface accompanying ND filter insertion and removal.

As described above, an example in which the ND filter is inserted from a state in which the ND filter is not inserted, and exposure control accompanying the ND filter insertion is performed, was explained by using FIG. 3. Conversely, an explanation will be provided below by using FIG. 3 with respect to an example in which the ND filter is removed from a state in which the ND filter is inserted, and exposure control accompanying the ND filter removal is performed.

That is, in a state in which the ND filter is inserted, after processing of step S301 and step S302 is performed, in step S303, determination of whether or not to remove the ND filter is performed. The threshold at that time uses Bv=x−y as described above.

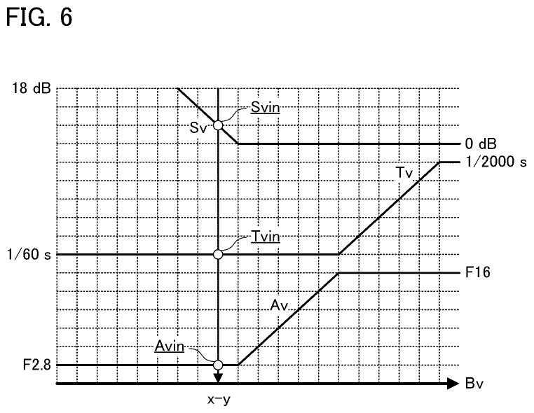

That is, in the determination during removal of the ND filter in step S303, a program line diagram as shown in FIG. 6, in which the threshold for removing the ND filter is set to x−y, is used as an alternative to the reference line diagram, and not, for example, a program line diagram of the type shown in FIG. 5A. That is, FIG. 6 is a diagram showing an example of a program line diagram that serves as a reference during ND filter removal according to the First Embodiment.

In a case in which the absolute brightness is determined to have fallen below Bv=x−y in step S303, the processing proceeds to step S304, and in a case in which No is determined in step S303, the processing returns to step S301.

In step S304, exposure parameters after ND filter removal are calculated, and in step S305, the program line diagram is regenerated.

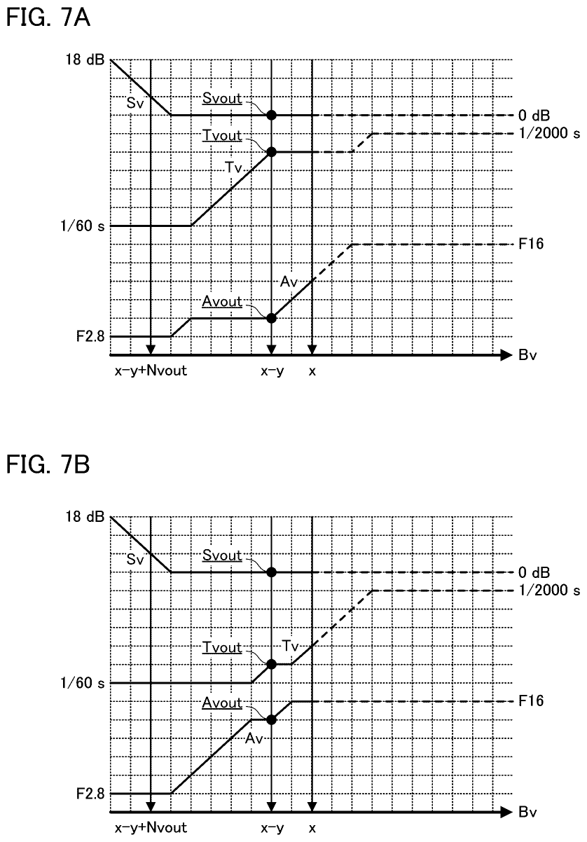

FIG. 7A and FIG. 7B are diagrams showing examples of program line diagrams regenerated during ND filter removal according to the First Embodiment.

FIG. 7A shows an example of a program line diagram regenerated in a case in which the program line diagram starts from Avout=4 (F4) during ND filter removal (when Bv=x−y), and FIG. 7B shows an example of a program line diagram regenerated in a case in which the program line diagram starts from Avout=7 (F11) during ND filter removal. It should be noted that Nvout is the change amount of the absolute brightness value Bv caused by ND filter removal, and Nvout has the relationship Nvout=−Nvin.

It should be noted that in program line diagrams such as FIG. 5A and FIG. 5B after ND filter insertion, when the absolute brightness value Bv exceeds x+Nvin, and thereafter falls below x+Nvin again, the program line diagram selection may be switched so that a program line diagram such as that of FIG. 6 is set.

This is because a line diagram regenerated based on the depth of the scene during ND filter insertion is not necessarily suitable during ND filter removal, and the program line diagram of FIG. 6 can be said to be a shape that most closely follows the design philosophy of the reference line diagram. In addition, the elapsed time from the previous ND filter insertion and removal, and the depth estimation results at a time at which the absolute brightness value falls below x+Nvin again, may be added as switching conditions.

Thereafter, in step S306, ND filter removal is performed, and after exposure parameters are changed, the processing returns to step S301.

### Second Embodiment

Hereinafter, an explanation will be provided with respect to operation of the image capturing apparatus according to a Second Embodiment of the present disclosure. In the First Embodiment, brightness x that is a threshold when inserting the ND filter and brightness x−y that is a threshold when removing the ND filter are fixed values, and insertion and removal of the ND filter is performed at a time at which the absolute brightness value Bv reaches either threshold.

However, even if the absolute brightness value Bv satisfies the above-described conditions for ND filter insertion and removal operations (brightness threshold conditions), it is desirable that ND filter insertion and removal operations at instances in which the importance of a scene is high be avoided. Accordingly, in the present embodiment, the ND filter insertion brightness x (first brightness) and the ND filter removal brightness x−y (second brightness) can be changed in accordance with the importance of a scene. That is, a first brightness set as an insertion condition of the ND filter and a second brightness set as a removal condition are changed based on the analysis results of a scene.

The configuration of the image capturing apparatus according to the Second Embodiment is the same as that of the First Embodiment, and explanation with respect to the configuration is omitted.

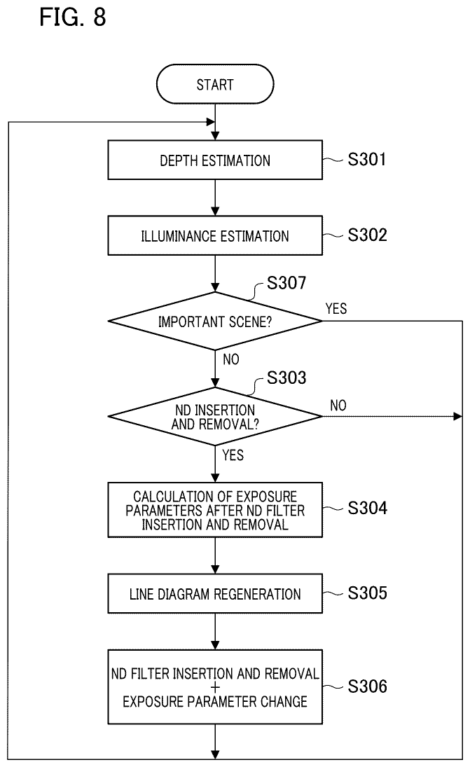

FIG. 8 is a flowchart showing an example of ND filter insertion and removal and exposure control accompanying the ND filter insertion and removal according to the Second Embodiment. It should be noted that operations of respective steps of the flowchart of FIG. 8 are performed sequentially by causing a CPU and the like serving as a computer within the camera control unit 108 to execute a computer program stored in memory.

It should be noted that steps having the same reference numerals as the First Embodiment correspond to the same processing, and accordingly, an explanation thereof is omitted. It should be noted that similar to the First Embodiment, an explanation will be provided with respect to a case in which the ND filter is inserted.

In step S307, before determination of ND filter insertion and removal, determination is performed of whether or not the scene is important as surveillance video. In the present embodiment, for example, presence or absence of movement of the subject is used as an index of importance as surveillance video. Here, step S307 functions as a scene analysis step (scene analysis unit) that analyzes movement of the subject or importance of the scene in addition to depth estimation in step S301.

Presence or absence of movement of the subject is determined by referring to the amount of change per unit time of the depth estimation results acquired in step S301 and the moving object estimation results from image analysis by the image signal processing unit 107. That is, movement includes speed information of the subject. It should be noted that moving object estimation may use known techniques such as calculation of motion vectors, optical flow, and the like, for example. In addition, similar to step S301, a region and a target for detecting movement may be limited to a predetermined subject set in advance by using known subject recognition techniques.

In a case in which movement of the subject is detected, that is, in a case in which an important scene is determined in step S307, the processing returns to step S301, and insertion and removal of the ND filter is not performed. In addition, in a case in which movement of the subject is not detected, that is, in a case in which No is determined in step S307, the processing transitions to step S303.

However, in a case in which it is determined from the illuminance estimation results of step S302 that maintaining proper exposure will become impossible unless ND filter insertion and removal is performed, that is, in a case in which absolute brightness is equal to or greater than a predetermined threshold (x+A), the processing proceeds to step S303 as an exception, even for an important scene.

In step S303, the brightness x that is a threshold for determining insertion of the ND filter is compared with the current absolute brightness value Bvnow. In a case in which the current absolute brightness value Bvnow exceeds the ND filter insertion brightness x, the processing proceeds to step S305 via step S304, and regeneration of the program line diagram is performed for the range of Bv from (x−y) to (Bvnow+Nvin).

For example, an explanation will be provided with respect to regeneration of the program line diagram in a case in which Bvnow=18, the scene is not an important scene, and ND filter insertion occurs.

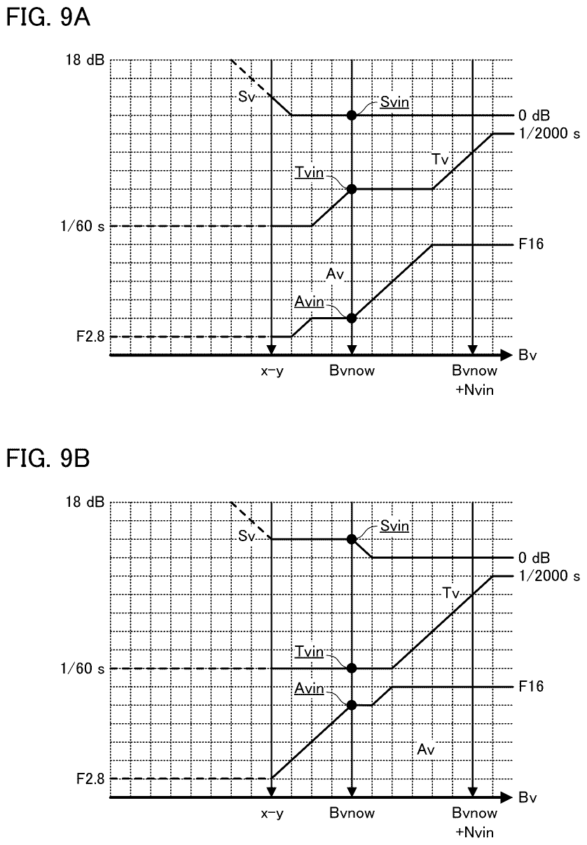

FIG. 9A and FIG. 9B are diagrams showing examples of program line diagrams regenerated during ND filter insertion according to the Second Embodiment. FIG. 9A shows a program line diagram regenerated in a case in which the program line diagram starts from Avout=4 (F4) during ND filter insertion, and FIG. 9B shows a program line diagram regenerated in a case in which the program line diagram starts from Avout=7 (F11) during ND filter insertion.

The line diagrams of FIG. 9A and FIG. 9B are stored in a memory device (not shown). Alternatively, the line diagrams may be stored in a network or various storage media.

It should be noted that regeneration of the program line diagram is generated in the ranges from Bvnow to (x−y) and from Bvnow to (Bvnow+Nvin), in accordance with the transition order of the respective parameters of the reference line diagram of FIG. 2, similar to the First Embodiment.

It should be noted that after insertion and removal of the ND filter, in a case in which the exposure settings from immediately before the insertion and removal are reached without undergoing another insertion and removal of the ND filter, automatic exposure control may be performed by referring to the first program line diagram or a third program line diagram generated based on the first program line diagram and the density of the ND filter.

In addition, the present disclosure includes implementations that realize functions of the above-described embodiments by using, for example, at least one processor such as a CPU, memory, and circuits (for example, ASIC), and the like. In addition, distributed processing may be performed by using a plurality of processors.

It should be noted that in order to realize some or all of control in the above-described embodiments, a computer program that realizes functions of the above-described embodiments may be supplied to an image capturing apparatus and the like via a network or various storage media. In addition, a computer (or CPU, MPU, and the like) in the image capturing apparatus and the like may read out and execute the computer program. In that case, the computer program, and a storage medium that stores the computer program, constitute the present disclosure.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, an image capturing apparatus configured to reduce image quality deterioration before and after ND filter insertion and removal can be provided.

This application claims the benefit of Japanese Patent Application No. 2024-167659, Sep. 26, 2024, which is hereby incorporated by reference wherein in its entirety.

What is claimed is:

1. An image capturing apparatus comprising:
an optical device including a Neutral Density (ND) filter;
a control unit;
a memory storing instructions; and
a processor executing the stored instructions causing the control unit to:
control at least two exposure parameters;
insert and remove the ND filter into and from an optical axis of the optical device; and
analyze a depth of an image capturing range, a movement of a subject, or an importance of a scene,
wherein the executing the stored instructions by the processor further causes the control unit to, at a time at which insertion and removal of the ND filter is performed, perform exposure control so as to offset brightness changes of output images accompanying the insertion and removal of the ND filter by using a combination of the exposure parameters and control amounts determined based on a result of the analyzing.

2. The image capturing apparatus according to claim 1, wherein the executing the stored instructions by the processor further causes the control unit to control, as the exposure parameters, at least two of an aperture diaphragm for controlling an amount of light incident on a light receiving surface of the optical device, a shutter speed, and a gain.

3. The image capturing apparatus according to claim 2, wherein the executing the stored instructions by the processor further causes the control unit to control the aperture diaphragm based on a depth of the subject, and control at least one of the shutter speed and the gain so as to offset brightness changes at the light receiving surface accompanying the insertion and removal of the ND filter.

4. The image capturing apparatus according to claim 1, wherein the memory stores a first program line diagram predetermining transitions of a plurality of exposure parameters corresponding to the brightness of the subject, and
wherein the executing the stored instructions by the processor further causes the control unit to, after the insertion and removal of the ND filter, perform the exposure control based on a second program line diagram generated based on a combination of the first program line diagram and the exposure parameters.

5. The image capturing apparatus according to claim 1, wherein the executing the stored instructions by the processor further causes the control unit to change a first brightness set as an insertion condition of the ND filter and a second brightness set as a removal condition based on the analyzed result.

6. The image capturing apparatus according to claim 1, wherein the executing the stored instructions by the processor further causes the control unit to, after the insertion and removal of the ND filter, in a case in which an exposure setting from immediately before the insertion and removal is reached without undergoing insertion and removal of the ND filter, perform the exposure control by referring to the first program line diagram or a third program line diagram generated based on the first program line diagram and a density of the ND filter.

7. The image capturing apparatus according to claim 1, wherein the depth includes distance information from the image capturing apparatus to at least a plurality of subjects.

8. The image capturing apparatus according to claim 1, wherein the movement includes speed information of the subject.

9. A control method for controlling an image capturing apparatus that includes an optical device including a Neutral Density (ND) filter, the control method comprising:
controlling at least two exposure parameters;
inserting and removing the ND filter into and from an optical axis of the optical device; and
analyzing a depth of an image capturing range, a movement of a subject, or an importance of a scene,
wherein, at a time at which insertion and removal of the ND filter is performed, exposure control is performed so as to offset brightness changes of output images accompanying the insertion and removal of the ND filter by using a combination of the exposure parameters and control amounts determined based on a result of the analyzing.

10. A non-transitory storage medium storing a program for an image capturing apparatus that includes an optical device including a Neutral Density (ND) filter, the program causing a computer to perform a method for the image capturing apparatus, the method comprising:
controlling at least two exposure parameters;
inserting and removing the ND filter into and from an optical axis of the optical device; and
analyzing a depth of an image capturing range, a movement of a subject, or an importance of a scene,
wherein, at a time at which insertion and removal of the ND filter is performed, exposure control is performed so as to offset brightness changes of output images accompanying the insertion and removal of the ND filter by using a combination of the exposure parameters and control amounts determined based on a result of the analyzing.
